(19) United States
(12) Patent Application Publication
(10) Pub. No.: US 2021/0140774 A1
(43) Pub. Date: May 13, 2021

(54) SYSTEMS AND METHODS FOR RECOMMENDING PICK-UP LOCATIONS

(71) Applicant: BEIJING DIDI INFINITY TECHNOLOGY AND DEVELOPMENT CO., LTD., Beijing (CN)

(72) Inventors: Ji ZHAO, Beijing (CN); Gaojie YAN, Beijing (CN); Hao LI, Beijing (CN); Weihuan SHU, Beijing (CN)

(73) Assignee: BEIJING DIDI INFINITY TECHNOLOGY AND DEVELOPMENT CO., LTD., Beijing (CN)

(21) Appl. No.: 17/100,999

(22) Filed: Nov. 23, 2020

Related U.S. Application Data
(63) Continuation of application No. PCT/CN2018/088720, filed on May 28, 2018.

(51) Int. Cl. G01C 21/34; G06Q 10/04; G06Q 50/30; G06N 5/04; G01C 21/00

(52) U.S. Cl. CPC G01C 21/343; G06Q 10/047; G01C 21/3811; G06N 5/04; G06Q 50/30

(57) ABSTRACT

A method for recommending pick-up locations is provided. The method may include one or more of the following operations. A start location may be obtained from a requester terminal. One or more candidate pick-up locations may be determined based on the start location and historical data. The historical data may include one or more historical start locations within a threshold distance from the start location. Location information of the one or more candidate pick-up locations may be obtained. One or more recommended pick-up locations may be selected among the one or more candidate pick-up locations based on the location information of the one or more candidate pick-up locations. The one or more recommended pick-up locations may be transmitted to the requester terminal.

### CROSS-REFERENCE TO RELATED APPLICATIONS

This application is a continuation of International Patent Application No. PCT/CN2018/088720, filed on May 28, 2018, the contents of which are hereby incorporated by reference.

### TECHNICAL FIELD

The present disclosure generally relates to Online to Offline (O2O) services and platforms, and more specifically, to methods and systems for recommending pick-up locations for transportation services and platforms.

### BACKGROUND

O2O services, especially online car hailing services, have become more and more popular. When a service requester (e.g., a passenger) requests a car via an online car hailing service platform using a user terminal, the server usually recommends pick-up locations for both the service requester and a service provider (e.g., a driver) who provides transportation service to the service requester. The pick-up locations are often determined based on Global Position System (GPS) information of the user terminal. A problem of determining the pick-up locations based on GPS information is that in some occasions the GPS information lacks precision and stability. Accordingly, it is desirable to provide systems and methods for recommending pick-up locations more precisely and steadily.

### SUMMARY

In a first aspect of the present disclosure, a system may include and at least one storage medium for storing instructions at least one processor in communication with the at least one computer-readable storage medium. When executing the instructions, the at least one processor may be directed to perform a method including one or more of the following operations. A start location may be obtained from a requester terminal. One or more candidate pick-up locations may be determined based on the start location and historical data. The historical data may include one or more historical start locations within a threshold distance from the start location. Location information of the one or more candidate pick-up locations may be obtained. One or more recommended pick-up locations may be selected among the one or more candidate pick-up locations based on the location information of the one or more candidate pick-up locations. The one or more recommended pick-up locations may be transmitted to the requester terminal.

In some embodiments, when executing the instructions to determine the one or more candidate pick-up locations based on the start location and the historical data, the at least one processor may be directed to perform one or more of the following operations. A historical pick-up location corresponding to each of the one or more historical start locations may be determined based on the historical data. The one or more candidate pick-up locations may be determined based on the one or more historical pick-up locations corresponding to the one or more historical start locations.

In some embodiments, when executing the instructions to determine the historical pick-up location corresponding to each of the one or more historical start locations, the at least one processor may be directed to perform one or more of the following operations. A first route of a historical requester terminal corresponding to the historical start location may be obtained. A second route of a historical provider terminal corresponding to the historical start location may be obtained. A converging point of the first route and the second route may be determined. The converging point may be designated as the historical pick-up location corresponding to the historical start location when the converging point is projectable to a link in an updated road map.

In some embodiments, the first route may include one or more first point sets. Each first location set may reflect a historical location of the historical requester terminal. The second route may include one or more second point sets. Each second point set may reflect a historical location of the historical provider terminal. When executing the instructions to determine the converging point of the first route and the second route, the at least one processor may be directed to perform one or more of the following operations. A matching pair of first point set and second point set may be determined among the one or more first point sets and the one or more second point sets. The converging point of the first route and the second route may be determined based on the second point set of the matching pair.

In some embodiments, when executing the instructions to select the one or more recommended pick-up locations, the at least one processor may be directed to perform one or more of the following operations. For each of the one or more candidate pick-up locations, an optimal route from the start location to each of the one or more candidate pick-up locations may be identified. Whether each of the optimal route includes road-crossing may be determined. The corresponding candidate pick-up location may be removed as a possible recommended pick-up location upon a determination that the optimal route includes road-crossing.

In some embodiments, when executing the instructions to transmit the one or more recommended pick-up locations to the requester terminal, the at least one processor may be directed to perform one or more of the following operations. The one or more recommended pick-up locations may be ranked. Part or all of the one or more recommended pick-up locations may be transmitted to the requester terminal based on the ranking result.

In some embodiments, when executing the instructions to rank the one or more recommended pick-up locations, the at least one processor may be directed to perform one or more of the following operations. Usage information related to one or more historical start locations corresponding to the one or more recommended pick-up location may be obtained. The one or more recommended pick-up locations may be ranked based on the usage information.

In some embodiments, when executing the instructions to rank the one or more recommended pick-up locations, the at least one processor may be directed to perform one or more of the following operations. Link information related to the one or more recommended pick-up locations may be obtained. The one or more recommended pick-up locations may be ranked based on the link information.

In some embodiments, when executing the instructions, the at least one processor may be directed to update a road map including a plurality of links surrounding the start location.

In a second aspect of the present disclosure, a method may be implemented on a computing device. The computing device may have at least one processor, at least one computer-readable storage medium, and a communication platform connected to a network. The method may include one or more of the following operations. A start location may be obtained from a requester terminal. One or more candidate pick-up locations may be determined based on the start location and historical data. The historical data may include one or more historical start locations within a threshold distance from the start location. Location information of the one or more candidate pick-up locations may be obtained. One or more recommended pick-up locations may be selected among the one or more candidate pick-up locations based on the location information of the one or more candidate pick-up locations. The one or more recommended pick-up locations may be transmitted to the requester terminal.

In a third aspect of the present disclosure, a non-transitory computer-readable storage medium may store instructions that, when executed by at least one processor of a system, cause the system to perform a method including one or more of the following operations. A start location may be obtained from a requester terminal. One or more candidate pick-up locations may be determined based on the start location and historical data. The historical data may include one or more historical start locations within a threshold distance from the start location. Location information of the one or more candidate pick-up locations may be obtained. One or more recommended pick-up locations may be selected among the one or more candidate pick-up locations based on the location information of the one or more candidate pick-up locations. The one or more recommended pick-up locations may be transmitted to the requester terminal.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary O2O service system according to some embodiments of the present disclosure;

FIG. 2 is a schematic diagram illustrating exemplary hardware and software components of a computing device according to some embodiments of the present disclosure;

FIG. 3 is a schematic diagram illustrating exemplary hardware and/or software components of a mobile device on which a terminal may be implemented according to some embodiments of the present disclosure;

FIG. 4 is a block diagram illustrating an exemplary processing engine according to some embodiments of the present disclosure;

FIG. 5 is a flowchart illustrating an exemplary process for recommending pick-up locations according to some embodiments of the present disclosure;

FIG. 6 is a flowchart illustrating an exemplary process for determining one or more candidate pick-up locations according to some embodiments of the present disclosure;

FIG. 7 is a flowchart illustrating an exemplary process for determining a historical pick-up location corresponding to a historical start location in a historical service order according to some embodiments of the present disclosure;

FIG. 8 is a flowchart illustrating an exemplary process for determining whether a candidate pick-up location is selected as a recommended pick-up location according to some embodiments of the present disclosure; and

FIG. 9 illustrates an exemplary road map surrounding a historical start location according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, section or assembly of different level in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in a firmware, such as an erasable programmable read-only memory (EPROM). It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Embodiments of the present disclosure may be applied to different transportation systems including but not limited to land transportation, sea transportation, air transportation, space transportation, or the like, or any combination thereof. A vehicle of the transportation systems may include a rickshaw, travel tool, taxi, chauffeured car, hitch, bus, rail transportation (e.g., a train, a bullet train, high-speed rail, and subway), ship, airplane, spaceship, hot-air balloon, driverless vehicle, or the like, or any combination thereof. The transportation system may also include any transportation system that applies management and/or distribution, for example, a system for sending and/or receiving an express.

The application scenarios of different embodiments of the present disclosure may include but not limited to one or more webpages, browser plugins and/or extensions, client terminals, custom systems, intracompany analysis systems, artificial intelligence robots, or the like, or any combination thereof. It should be understood that application scenarios of the system and method disclosed herein are only some examples or embodiments. Those having ordinary skills in the art, without further creative efforts, may apply these drawings to other application scenarios. For example, other similar server.

The term “passenger,” “requester,” “requestor,” “service requester,” “service requestor” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a requester, a passenger, a driver, an operator, or the like, or any combination thereof. In the present disclosure, “requester” and “requester terminal” may be used interchangeably, and “provider” and “provider terminal” may be used interchangeably.

The term “request,” “service,” “service request,” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

The present disclosure relates to systems and methods for determining one or more recommended pick-up locations for a start location obtained from a requester terminal. The system and methods may determine one or more candidate pick-up locations based on the start location and historical data. The historical data may include one or more historical start locations within a threshold distance from the start location. One or more historical pick-up locations corresponding to the one or more historical start locations may be designated as the one or more candidate pick-up locations. The systems and methods may also select the one or more recommended pick-up locations among the one or more candidate pick-up locations. For example, candidate pick-up location(s) far away from the start location may be removed as possible recommended pick-up location(s). As another example, candidate pick-up location(s) whose optimal route(s) to the start location include road-crossing may be removed as possible recommended pick-up location(s). The systems and methods may further transmit the one or more recommended pick-up locations to the requester terminal.

FIG. 1 is a block diagram illustrating an exemplary O2O service system 100 according to some embodiments of the present disclosure. For example, the O2O service system 100 may be an online transportation service platform for transportation services. The O2O service system 100 may include a server 110, a network 120, a requester terminal 130, a provider terminal 140, a vehicle 150, a storage device 160, and a navigation system 170.

The O2O service system 100 may provide a plurality of services. Exemplary service may include a taxi-hailing service, a chauffeur service, an express car service, a carpool service, a bus service, a driver hire service, and a shuttle service. In some embodiments, the O2O service may be any on-line service, such as booking a meal, shopping, or the like, or any combination thereof.

In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the requester terminal 130, the provider terminal 140, and/or the storage device 160 via the network 120. As another example, the server 110 may be directly connected to the requester terminal 130, the provider terminal 140, and/or the storage device 160 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data related to the service request to perform one or more functions described in the present disclosure. For example, the processing engine 112 may determine one or more candidate provider terminals in response to the service request received from the requester terminal 130. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the O2O service system 100 (e.g., the server 110, the requester terminal 130, the provider terminal 140, the vehicle 150, the storage device 160, and the navigation system 170) may transmit information and/or data to other component(s) of the O2O service system 100 via the network 120. For example, the server 110 may receive a service request from the requester terminal 130 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, through which one or more components of the O2O service system 100 may be connected to the network 120 to exchange data and/or information.

In some embodiments, a passenger may be an owner of the requester terminal 130. In some embodiments, the owner of the requester terminal 130 may be someone other than the passenger. For example, an owner A of the requester terminal 130 may use the requester terminal 130 to transmit a service request for a passenger B or receive a service confirmation and/or information or instructions from the server 110. In some embodiments, a service provider may be a user of the provider terminal 140. In some embodiments, the user of the provider terminal 140 may be someone other than the service provider. For example, a user C of the provider terminal 140 may use the provider terminal 140 to receive a service request for a service provider D, and/or information or instructions from the server 110. In some embodiments, “passenger” and “passenger terminal” may be used interchangeably, and “service provider” and “provider terminal” may be used interchangeably. In some embodiments, the provider terminal may be associated with one or more service providers (e.g., a night-shift service provider, or a day-shift service provider).

In some embodiments, the requester terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glasses, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google™ Glass, an Oculus Rift, a HoloLens, a Gear VR, etc. In some embodiments, the built-in device in the vehicle 130-4 may include an onboard computer, an onboard television, etc. In some embodiments, the requester terminal 130 may be a device with positioning technology for locating the position of the passenger and/or the requester terminal 130.

The provider terminal 140 may include a plurality of provider terminals 140-1, 140-2, . . . , 140-n. In some embodiments, the provider terminal 140 may be similar to, or the same device as the requester terminal 130. In some embodiments, the provider terminal 140 may be customized to be able to implement the online on-demand transportation service. In some embodiments, the provider terminal 140 may be a device with positioning technology for locating the service provider, the provider terminal 140, and/or a vehicle 150 associated with the provider terminal 140. In some embodiments, the requester terminal 130 and/or the provider terminal 140 may communicate with another positioning device to determine the position of the passenger, the requester terminal 130, the service provider, and/or the provider terminal 140. In some embodiments, the requester terminal 130 and/or the provider terminal 140 may periodically transmit the positioning information to the server 110. In some embodiments, the provider terminal 140 may also periodically transmit the availability status to the server 110. The availability status may indicate whether a vehicle 150 associated with the provider terminal 140 is available to carry a passenger. For example, the requester terminal 130 and/or the provider terminal 140 may transmit the positioning information and the availability status to the server 110 every thirty minutes. As another example, the requester terminal 130 and/or the provider terminal 140 may transmit the positioning information and the availability status to the server 110 each time the user logs into the mobile application associated with the online on-demand transportation service.

In some embodiments, the provider terminal 140 may correspond to one or more vehicles 150. The vehicles 150 may carry the passenger and travel to the destination. The vehicles 150 may include a plurality of vehicles 150-1, 150-2, . . . , 150-n. One vehicle may correspond to one type of services (e.g., a taxi-hailing service, a chauffeur service, an express car service, a carpool service, a bus service, a driver hire service, or a shuttle service).

The storage device 160 may store data and/or instructions. In some embodiments, the storage device 160 may store data obtained from the requester terminal 130 and/or the provider terminal 140. In some embodiments, the storage device 160 may store data and/or instructions that the server 110 may execute or use to perform exemplary methods described in the present disclosure. In some embodiments, storage device 160 may include a mass storage, removable storage, a volatile read-and-write memory, a read-only memory (ROM), or the like, or any combination thereof. Exemplary mass storage may include a magnetic disk, an optical disk, solid-state drives, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 160 may be connected to the network 120 to communicate with one or more components of the O2O service system 100 (e.g., the server 110, the requester terminal 130, or the provider terminal 140). One or more components of the O2O service system 100 may access the data or instructions stored in the storage device 160 via the network 120. In some embodiments, the storage device 160 may be directly connected to or communicate with one or more components of the O2O service system 100 (e.g., the server 110, the requester terminal 130, the provider terminal 140). In some embodiments, the storage device 160 may be part of the server 110.

The navigation system 170 may determine information associated with an object, for example, one or more of the requester terminal 130, the provider terminal 140, the vehicle 150, etc. In some embodiments, the navigation system 170 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The navigation system 170 may include one or more satellites, for example, a satellite 170-1, a satellite 170-2, and a satellite 170-3. The satellites 170-1 through 170-3 may determine the information mentioned above independently or jointly. The satellite navigation system 170 may transmit the information mentioned above to the network 120, the requester terminal 130, the provider terminal 140, or the vehicle 150 via wireless connections.

In some embodiments, one or more components of the O2O service system 100 (e.g., the server 110, the requester terminal 130, the provider terminal 140) may have permissions to access the storage device 160. In some embodiments, one or more components of the O2O service system 100 may read and/or modify information related to the passenger, service provider, and/or the public when one or more conditions are met. For example, the server 110 may read and/or modify one or more passengers' information after a service is completed. As another example, the server 110 may read and/or modify one or more service providers' information after a service is completed.

In some embodiments, information exchanging of one or more components of the O2O service system 100 may be initiated by way of requesting a service. The object of the service request may be any product. In some embodiments, the product may include food, medicine, commodity, chemical product, electrical appliance, clothing, car, housing, luxury, or the like, or any combination thereof. In some other embodiments, the product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application related to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element (or component) of the O2O service system 100 performs, the element may perform through electrical signals and/or electromagnetic signals. For example, when a requester terminal 130 transmits out a service request to the server 110, a processor of the requester terminal 130 may generate an electrical signal encoding the request. The processor of the requester terminal 130 may then transmit the electrical signal to an output port. If the requester terminal 130 communicates with the server 110 via a wired network, the output port may be physically connected to a cable, which further may transmit the electrical signal to an input port of the server 110. If the requester terminal 130 communicates with the server 110 via a wireless network, the output port of the requester terminal 130 may be one or more antennas, which convert the electrical signal to electromagnetic signal. Similarly, a provider terminal 130 may receive an instruction and/or service request from the server 110 via electrical signal or electromagnet signals. Within an electronic device, such as the requester terminal 130, the provider terminal 140, and/or the server 110, when a processor thereof processes an instruction, transmits out an instruction, and/or performs an action, the instruction and/or action is conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 illustrates a schematic diagram of an exemplary computing device according to some embodiments of the present disclosure. The computing device may be a computer, such as the server 110 in FIG. 1 and/or a computer with specific functions, configured to implement any particular system according to some embodiments of the present disclosure. Computing device 200 may be configured to implement any components that perform one or more functions disclosed in the present disclosure. For example, the server 110 may be implemented in hardware devices, software programs, firmware, or any combination thereof of a computer like computing device 200. For brevity, FIG. 2 depicts only one computing device. In some embodiments, the functions of the computing device, providing function that recommending pick-up locations may require, may be implemented by a group of similar platforms in a distributed mode to disperse the processing load of the system.

Computing device 200 may include a communication terminal 250 that may connect with a network that may implement the data communication. Computing device 200 may also include a processor 220 that is configured to execute instructions and includes one or more processors. The schematic computer platform may include an internal communication bus 285, different types of program storage units and data storage units (e.g., a hard disk 270, a read-only memory (ROM) 230, a random-access memory (RAM) 240), various data files applicable to computer processing and/or communication, and some program instructions executed possibly by the processor 220. Computing device 200 may also include an I/O device 260 that may support the input and output of data flows between computing device 200 and other components. Moreover, computing device 200 may receive programs and data via the communication network.

FIG. 3 is a schematic diagram illustrating exemplary hardware and/or software components of an exemplary mobile device 300 on which a terminal may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, a mobile operating system (OS) 370, a storage 390. In some embodiments, any other suitable component, including but not limited to a system bus or a controller (not shown), may also be included in the mobile device 300.

In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the O2O service system 100. User interactions with the information stream may be achieved via the I/O 350 and provided to the database 130, the server 105 and/or other components of the O2O service system 100. In some embodiments, the mobile device 300 may be an exemplary embodiment corresponding to the requester terminal 130 or the provider terminal 140.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a system if appropriately programmed.

FIG. 4 is a block diagram illustrating an exemplary processing engine 112 according to some embodiments of the present disclosure. The processing engine 112 may include an acquisition module 410, a determination module 420, a selection module 430, a ranking module 440, and a transmission module 450.

The modules may be hardware circuits of all or part of the processing engine 112. The modules may also be implemented as an application or set of instructions read and executed by the processing engine 112. Further, the modules may be any combination of the hardware circuits and the application/instructions. For example, the modules may be the part of the processing engine 112 when the processing engine 112 is executing the application/set of instructions.

The acquisition module 410 may be configured to acquire information related to the O2O service system 100. In some embodiments, the acquisition module 410 may acquire information related but not limited to a location (e.g., a start location, a historical start location, a candidate pick-up location, a recommended pick-up location), a service order, a user (e.g., a service requester, a service provider), a route (e.g., a route of a requester terminal, a route of a provider terminal), or the like, or any combination thereof. For example, the acquisition module 410 may acquire a start location where a requester terminal 130 wants and/or needs to receive an O2O service. As another example, the acquisition module 410 may acquire location information of one or more candidate pick-up locations corresponding to the start location. As yet another example, the acquisition module 410 may acquire a route of a historical requester terminal or a historical provider terminal in at least part of the process of a historical service order.

The determination module 420 may be configured to determine one or more candidate pick-up locations corresponding to a start location. In some embodiments, the determination module 420 may determine one or more locations that is easy to identify and within a first threshold distance from the start location, and designate the location(s) as the candidate pick-up location(s). In some embodiments, the determination module 420 may determine the candidate pick-up location(s) based on the start location and historical data. For example, the determination module 420 may determine the candidate pick-up location(s) based on historical start locations within a second threshold from the start location. More descriptions regarding the determination of the candidate pick-up locations may be found elsewhere in the present disclosure. See, e.g., operation 520 and the relevant descriptions thereof.

In some embodiments, the determination module 420 may also be configured to determine a historical pick-up location corresponding to a historical start location in a historical service order. For example, the determination module 420 may determine a converging point of a first route of a historical requester terminal and a second route of a historical provider terminal. Then the determination module 420 may designate the converging point as the historical pick-up location corresponding to the historical start location. More descriptions regarding the determination of the historical pick-up location may be found elsewhere in the present disclosure. See, e.g., FIG. 7 and the relevant descriptions thereof.

The selection module 430 may be configured to select one or more recommended pick-up locations among one or more candidate pick-up locations. In some embodiments, the selection module 430 may select the recommended pick-up location(s) randomly or according to location information of the one or more candidate pick-up locations. For example, the selection module 430 may select the recommended pick-up location(s) based on the respective distances between the candidate pick-up locations and the start location. As another example, the selection module 430 may identify an optimal route from the start location to each of the candidate pick-up location(s). In certain embodiments, the selection module 430 may also determine whether the optimal route(s) of the candidate pick-up location(s) includes road-crossing, and select the recommended pick-up location(s) based on the determination. More descriptions regarding the selection of the recommended pick-up location(s) can be found elsewhere in the present disclosure. See, e.g., operation 540 and the relevant descriptions.

The ranking module 440 may be configured to rank one or more locations related to the O2O service system 100. For example, the ranking module 440 may rank one or more recommended pick-up locations corresponding to a start location. In some embodiments, the one or more recommended pick-up location(s) may be ranked base on, for example, location information, usage information, link information, or the like, or any combination thereof. More descriptions regarding the ranking of the recommended pick-up location(s) can be found elsewhere in the present disclosure. See, e.g., operation 550 and the relevant descriptions.

The transmission module 450 may be configured to transmit information and/or instructions to one or more components in the O2O service system 100. For example, the transmission module 450 may transmit information and/or instructions to a requester terminal 130 and/or a provider terminal 140. In some embodiments, the transmission module 450 may transmit one or more recommended pick-up locations corresponding to a start location to a requester terminal 130 that initiates a service order from the start location. Additionally or alternatively, the transmission module 450 may transmit the one or more recommended pick-up locations to a corresponding provider terminal 140 that accepts the service order. In certain embodiments, the transmission module 450 may transmit part or all of one or more recommended pick-up locations corresponding to a start location based on a ranking result of the one or more recommended pick-up locations. More descriptions regarding the transmission of the recommended pick-up location(s) can be found elsewhere in the present disclosure. See, e.g., operation 560 and the relevant descriptions.

It should be noted that the above descriptions of the processing engine 112 are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, two or more modules may be integrated into one unit to perform the functions thereof. For example, the determination module 420 and the selection module 430 may be integrated into a single module to perform the functions thereof. In some embodiments, a module may be divided into a plurality of units.

FIG. 5 is a flowchart illustrating an exemplary process for recommending pick-up locations according to some embodiments of the present disclosure. At least a portion of process 500 may be implemented on the computing device 200 as illustrated in FIG. 2 or the mobile device 300 as illustrated in FIG. 3. In some embodiments, one or more operations of process 500 may be implemented in the O2O service system 100 as illustrated in FIG. 1. In some embodiments, one or more steps in the process 500 may be stored in the storage device 160 and/or the storage (e.g., the ROM 230, the RAM 240, etc.) as a form of instructions, and invoked and/or executed by the server 110 (e.g., the processing engine 112 in the server 110, or the CPU 220 of the processing engine 112 in the server 110). In some embodiments, the instructions may be transmitted in a form of electronic current or electrical signals.

In 510, the acquisition module 410 may obtain a start location from a requester terminal 130. As used herein, the start location may refer to a location where the requester terminal 130 wants and/or needs to receive an 020 service. The O2O service may include but not be limited to a taxi-hailing service, a chauffeur service, an express car service, a carpool service, a bus service, a driver hire service, a shuttle service, a take-out service, or the like, or any combination thereof. The start location may be any location. For example, the start location may include but not be limited to a building (e.g., a hospital, a supermarket, a school), a station (e.g., a bus station, a train station), a location along a street, a cross road, a scenery (e.g., a mountain, a river, a scenic spot), or the like, or any sub-part (e.g., a particular exit of a building) or combination thereof.

In some embodiments, the start location may be a current location of the requester terminal 130. For example, the current location of the requester terminal 130 may be set as the start location when a requester opens an application for the O2O service installed on the requester terminal 130, or initiates a service request via the requester terminal 130 and/or the application. The current location of the requester terminal 130 may be determined based on a positioning technology, such as but not limited to, a GPS positioning technology, a base station positioning technology, a WIFI positioning technology, etc. In some embodiments, the current location of the requester terminal 130 may be automatically transmitted to the acquisition module 410.

In some embodiments, the start location may be inputted by a requester via the requester terminal 130 and then transmitted to the acquisition module 410. The requester may input the start location by way of typing, writing, using his/her voice, making a gesture, touching an interface of the requester terminal 130, or the like, or any combination thereof. For example, the requester may input the start location by touching a screen of the requester terminal 130. Merely for illustration purposes, the requester terminal 130 may display a map on which the start location is marked by a pin, and the requester may move the start location by dragging the pin on the map. The moved start location may be set as the start location. In some embodiments, since the positioning technologies do not provide complete precision and accuracy, the current location of the requester terminal 130, as obtained by the acquisition module 410, may not be completely precise and accurate. Similarly, in some embodiments, the current as well as historical locations of the requester terminal 130 and the provider terminal 140, as provided through the positioning technologies, may or may not be complete precise or accurate. The current invention provides methods and systems that reduce the influence of such lack of precision and accuracy, providing recommended pick-up locations despite such imperfections.

In some embodiments, the start location may be related to a service request initiated via the requester terminal 130. The service request may include a real-time service request, an appointment request, and/or any other request for one or more types of services. The real-time request may indicate that the requester wishes to receive an O2O service at the present moment or at a defined time reasonably close to the present moment. The appointment request may indicate that the requester wishes to schedule an O2O service in advance (e.g., at a defined time which is not close to the present moment). In some embodiments, the service request may be initiated to request service for a user of the requester terminal 130. For example, a user of the requester terminal 130 may initiate a service request for his/herself via the requester terminal 130. In some embodiments, the service request may be initiated for another user (or another requester terminal 130). For example, a user of the requester terminal 130 may initiate a service request for another user via the requester terminal 130. While the embodiments of the present invention, with minor modifications known by a person skilled in the art, can be applied to the request-service-for-others scenario, the descriptions hereinafter use the request-service-for-self scenario as examples.

In 520, the determination module 420 may determine one or more candidate pick-up locations. A candidate pick-up location may refer to a candidate location where a service provider may pick up the requester of the requester terminal 130. A candidate pick-up location may include any location.

In some embodiments, a candidate pick-up location may be a location easy to identify within a first threshold distance from the start location. For example, the one or more candidate pick-up locations may include a crossroad, a building, a bus station, a community gate, a park gate, a school gate, and/or any location that is easy to identify and within the first threshold distance from the start location. The first threshold distance may be any positive value, such as but not limited to 5 m, 10 m, 20 m, 50 m, 100 m, or 200 m, or the like. The first threshold distance may be a default parameter stored in a storage device (e.g., the storage device 160) or be set by a user of the O2O service system 100. In some embodiments, the first threshold may be determined by one or more components in the O2O service system 100, such as but not limited to the processing engine 112. In some embodiments, the first threshold distance may vary with the request time, the requester, the start location, etc. Merely by way of example, a first threshold distance with respect to a start location in a city may be less than a first threshold distance with respect to the start location in a suburb.

In some embodiments, the one or more candidate pick-up locations may be determined based on the start location and historical data. The historical data may include any information related to historical service orders happened within a historical time and within a certain area. The historical time may be any historical time point, historical time interval (e.g., rush hours, day-time), a historical date section (e.g., a weekday, a weekend, a holiday, or a festival), or the like, or any combination thereof. The certain area may be any area that includes the start location. The certain area may be any size and shape. For example, the certain area may be an area within a certain radius around the start location. In some embodiments, the historical data related to a historical service order may include but not limited to a historical order time, a historical service requester, a historical requester terminal, a historical service provider, a historical provider terminal, a historical start location, a historical pick-up location, a first route of the historical requester terminal and/or a second route of the historical provider terminal in the process of the historical service order, a service price, a service type (e.g., carpooling service, non-carpooling service), or the like, or any combination thereof. In some embodiments, the historical data may be obtained from an external source and/or one or more components in the O2O service system 100, for example, request terminal 130, and/or the storage device 160.

In some embodiments, the historical data may include information related to one or more historical service orders initiated at historical start location(s) within a second threshold distance from the start location. The second threshold distance may be any positive value, such as but not limited to 5 m, 10 m, 20 m, 50 m, 100 m, or 200 m, or the like. The second threshold distance may be a default parameter stored in a storage device (e.g., the storage device 160) or be set by a user of the O2O service system 100. In some embodiments, the second threshold may be determined by one or more components in the O2O service system 100, such as but not limited to the processing engine 112. In some embodiments, the second threshold distance may vary with the request time, the requester, the start location, etc.

In some embodiments, the determination module 420 may acquire or determine one or more historical pick-up locations corresponding to the one or more historical start locations within the second threshold distance from the start location. The determination module 420 may also determine the candidate pick-up locations based on the historical pick-up locations. More descriptions regarding the determination of the one or more candidate pick-up locations can be found elsewhere in the present disclosure. See, e.g., FIGS. 6 and 7 and the relevant descriptions.

In some embodiments, the historical data may include information related to one or more historical pick-up locations within a third threshold distance from the start location. The third threshold distance may be any positive value, such as but not limited to 5 m, 10 m, 20 m, 50 m, 100 m, or 200 m, or the like. The third threshold distance may be a default parameter stored in a storage device (e.g., the storage device 160) or be set by a user of the O2O service system 100. In some embodiments, the third threshold may be determined by one or more components in the O2O service system 100, such as but not limited to the processing engine 112. In some embodiments, the third threshold distance may vary with the request time, the requester, the start location, etc. The determination module 420 may designate the one or more historical pick-up locations within the third threshold distance from the start location as the one or more candidate pick-up locations.

In 530, the acquisition module 410 may obtain location information of the one or more candidate pick-up locations. In some embodiments, the location information of a candidate pick-up location may include but be not limited to the address of the candidate pick-up location (e.g., the longitudinal and latitudinal coordinates), a distance between the candidate pick-up location and the start location, link information related to the candidate pick-up location, usage information related to the candidate pick-up location, or the like, or any combination thereof.

The distance between the candidate pick-up location and the start location may be a linear distance or a route distance between the two locations. The link information may include information related to a road (also referred to as a link herein) that leads to the candidate pick-up location. In some embodiments, the link information may include an identification (ID) of the link in a road map, the intersection(s) between the link and other link(s), the neighboring link(s) of the link, historical service order(s) happened in the link, historical start location(s), historical pick-up locations, and/or historical destinations along the link, or the like, or any combination thereof. In some embodiments, the road map including a plurality of links surrounding the start location may be continuously or periodically updated. The link information related to the candidate pick-up location may be continuously or periodically updated with the updating of the road map. For example, while the ID of a link in a road map may be 0001 in May, 2017, the ID of the link may change to 0003 in an updated road map in October, 2017. The usage information may include any information that may indicate the usage of the candidate pick-up location. Merely by way of example, the usage information may include but be not limited to the number of times or frequency that the candidate pick-up location served as a historical start location, a historical destination, or a historical pick-up location in one or more historical service orders.

In 540, the selection module 430 may select one or more recommended pick-up locations among the one or more candidate pick-up locations. In some embodiments, the selection module 430 may select the recommended pick-up location(s) among the candidate pick-up location(s) randomly or according to the location information of the candidate pick-up location(s). For example, the selection module 430 may select the recommended pick-up location(s) based on the respective distances between the candidate pick-up locations and the start location. The recommended pick-up location(s) may include all candidate pick-up location(s) whose distance(s) to the start location are within a threshold, top N candidate pick-up location(s) closest to the start location, or the like, or any combination thereof. As another example, the selection module 430 may select the recommended pick-up location(s) based on the number of times or frequency that the candidate pick-up location served as a historical pick-up location in one or more historical service orders. In certain embodiments, a candidate pick-up location that served as a historical pick-up location for more than a certain number of times may be selected as a recommended pick-up location.

In some embodiments, for each of the candidate pick-up location(s), the selection module 430 may identify an optimal route from the candidate pick-up location to the start location. In certain embodiments, the selection module 430 may also determine whether the optimal route(s) of the candidate pick-up location(s) includes road-crossing, and select the recommended pick-up location(s) based on the determination. More descriptions regarding the determination as to whether a candidate pick-up location is selected as a recommended pick-up location can be found elsewhere in the present disclosure. See, e.g., FIG. 8 and the relevant descriptions.

In 550, the ranking module 440 may rank the one or more recommended pick-up locations. In some embodiments, the one or more recommended pick-up location(s) may be ranked base on, for example, location information, usage information, link information, or the like, or any combination thereof. For example, the ranking module 440 may rank the recommended pick-up location(s) according to their distances to the start location (e.g., in descending order).

As another example, the ranking module 440 may rank the recommended pick-up location(s) according to usage information of the recommended pick-up location(s). The usage information may include but is not limited to the number of times or frequency that the candidate pick-up location served as a historical start location, a historical destination, or a historical pick-up location in one or more historical service orders. For example, the ranking module 440 may rank the candidate pick-up location(s) based on the number of times or frequency (the number of times in a predetermined period of time) that the candidate pick-up location(s) serve as a historical start location from, for example, high to low.

In some embodiments, the recommended pick-up location(s) may include one or more historical pick-up locations as described in connection with 520. The ranking module 440 may determine a popularity of these recommended pick-up location(s) based on their usage information, and then rank the recommended pick-up location(s) based on their popularities from, for example, high to low. When a recommended pick-up location corresponds to a single historical start location in one or more historical service orders, the popularity of the recommended pick-up location may be equal to the number of historical service orders that were initiated at the historical start location and in which the recommended pick-up location served as a historical pick-up location. For example, the number of historical service orders that were initiated at the historical start location and in which the recommended pick-up location served as the historical pick-up location is 5, and the ranking module 440 may determine the popularity of the recommended pick-up location based on the number 5 (e.g., the popularity can be quantified as 5).

When a recommended pick-up location corresponds to a plurality of historical start locations in one or more historical service orders, the popularity of the recommended pick-up location may be determined according to Equation (1) as below:

p_{location}=Σᵢ₌₁²pᵢdᵢ, (1)

where p_{location} represents the popularity of the recommended pick-up location, n represents the number of historical start locations corresponding to the recommended pick-up location, i represents an ith historical start location corresponding to the recommended pick-up location, pᵢ represents the number historical service orders that were initiated at the ith historical start location and in which the recommended pick-up location served as the historical pick-up location, dᵢ represents a decay factor of the ith historical start location. In some embodiments, dᵢ may be determined according to Equation (2) as below:

$${d}_{i} = ( 0.5 \times ( \frac{1}{2 r} ) ) \times dist , \qquad ( 2 )$$

where r represents a distance parameter, dist represents a distance between the start location and the i^{th} historical start location. In some embodiments, r may be a default parameter stored in a storage device (e.g., the storage device 160) or set by a user of the O2O service system 100. In certain embodiments, r may be equal to a half of the second threshold distance as described in connection with 520. For example, in 520, the determination module 420 may determine one or more historical start locations within 50 meters from the start location, and then designate historical pick-up location(s) corresponding to the historical start location(s) as the recommended pick-up locations. The r may be equal to a half of 50 meters (i.e. 25 meters).

In some embodiments, the ranking module 440 may rank the one or more recommended pick-up locations based on link information. The link information may be related to the link(s) where the recommended pick-up location(s) locate. For example, the ranking module 440 may rank the link(s) where the recommended pick-up location(s) locate, and then rank the recommended pick-up location(s) according to the ranking result of the link(s). In some embodiments, the ranking module 440 may rank the recommended pick-up location(s) located at a high-ranking link in front of the recommended pick-up location(s) located at a low-ranking link.

In some embodiments, the ranking module 440 may determine a popularity of the link(s) where the recommended pick-up location(s) locates, and rank the link(s) based on their popularities from, for example, high to low. In some embodiments, the popularity of a link may be measured by, such as but not limited to a population density or building density of the link, a number of historical pick-up locations along the link, a number of historical destinations along the link, a number of the historical start locations along the link, or the like, or any combination thereof. In some embodiments, the popularity of a link may be determined according to Equation (3) below:

pₗᵢₙₖ=Σⱼ₌₁^{m}p′ⱼd′ⱼ, (3)

where pₗᵢₙₖ represents the popularity of the link, m represents the number of the recommended pick-up location(s) along the link, j represents an j^{th} recommended pick-up location along the link, p′ⱼ represents the popularity of the j^{th} recommended pick-up location along the link, and d′ⱼ represents a decay factor of the j^{th} recommended pick-up location. In some embodiments, d′ⱼ may be determined according to Equation (4) as below:

$${d}_{j}^{′} = ( 0.5 \times ( \frac{1}{2 r} ) ) \times {dist}^{′} , \qquad ( 4 )$$

where r represents the distance parameter, dist′ represents the distance between the start location and the j^{th} recommended pick-up location.

In some embodiments, the ranking module 440 may rank the recommended pick-up location(s) according to both the usage information of the recommended pick-up location(s) and the linking information related to the link(s) where the recommended pick-up location(s) locate. For example, the ranking module 440 may rank recommended pick-up location(s) based on the ranking result of the link(s). Then the ranking module 440 may further rank the ranked recommended pick-up location(s) located at a same link based on the usage information of the ranked recommended pick-up locations(s).

In 560, the transmission module 450 may transmit part or all of the one or more recommended pick-up locations to the requester terminal 130 based on the ranking result. In some embodiments, the transmission module 450 may transmit part or all of the one or more recommended pick-up locations to the requester terminal 130 via the network 120. For example, the transmission module 450 may transmit top N recommended pick-up locations among the one or more recommended pick-up locations to the requester terminal 130. The N may be any positive integer value (e.g., 1, 2, 3, 4, or 5) or any percentage value (e.g., 10%, 20%, 30%, 40%, or 90%).

In some embodiments, the transmission module 450 may also transmit the recommended pick-up location(s) to a provider terminal 140 (e.g., a driver's terminal) who accepts the service request initiated by the requester terminal 130. In some embodiments, the requester terminal 130 and/or the provider terminal 140 may display the recommended pick-up location(s) to the service requester and/or the service provider. In some embodiments, only the top recommended pick-up locations (e.g., top 3 recommended pick-up locations, top 5 recommended pick-up locations, or top 10% recommended pick-up locations, etc.) in the ranking result may be displayed. In some embodiments, the recommended pick-up locations may be displayed in different ways based on the ranking result. For example, the size of the recommended pick-up locations may be inversely proportional to its rank in the ranking result (e.g., recommended pick-up location number 1 has the largest size, etc). As another example, top 3 recommended pick-up locations in the ranking result may be displayed in red and other recommended pick-up locations may be displayed in grey. In some embodiments, the way of displaying the one or more recommended pick-up locations may be set by the service requester of the requester terminal 130 and/or the service provider of the provider terminal 140.

In some embodiments, the service requester and/or the service provider may interact with the displayed recommended pick-up location(s). Merely by way of example, the service requester may select a desired pick-up location from recommended pick-up location(s) by way of, such as but not limited to clicking or reading out the desired pick-up location.

It should be noted that the above description regarding the process 500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations in the process 500 may be omitted or one or more additional operations may be added. For example, 530 and 540 may be omitted. The determination module 420 may designate the candidate pick-up location(s) determined in 520 as the recommended pick-up location(s). As another example, 550 and/or 560 may be omitted.

FIG. 6 is a flowchart illustrating an exemplary process for determining one or more candidate pick-up locations according to some embodiments of the present disclosure. At least a portion of process 600 may be implemented on the computing device 200 as illustrated in FIG. 2 or the mobile device 300 as illustrated in FIG. 3. In some embodiments, one or more operations of process 600 may be implemented in the O2O service system 100 as illustrated in FIG. 1. In some embodiments, one or more steps in the process 600 may be stored in the storage device 160 and/or the storage (e.g., the ROM 230, the RAM 240, etc.) as a form of instructions, and invoked and/or executed by the server 110 (e.g., the processing engine 112 in the server 110, or the CPU 220 of the processing engine 112 in the server 110). In some embodiments, part of all of the process 600 may be performed to achieve operation 520 as described in connection with FIG. 5.

In 610, the determination module 420 may determine one or more historical pick-up locations corresponding to each of the one or more historical start locations based on the historical data. The historical start location(s) may be located within a second threshold distance from the start location as described in connection with 520. The historical data related to a historical start location may include information related to one or more historical service orders initiated at the historical start location(s). In some embodiments, the historical data related to a historical start location may include historical pick-up locations of the historical service order(s) initiated at the historical start location. For each of the historical start locations, the determination module 420 may acquire the historical pick-up location(s) corresponding to the historical start location based on the historical data.

In some embodiments, the historical data related to a historical start location may include a first route of a historical requester terminal and a second route of a historical provider terminal in each of the historical service order(s) initiated at the historical start location. In some embodiments, the historical pick-up location corresponding to a historical start location in a historical service order may be determined based on a converging point of the two routes. More descriptions regarding the determination of a historical pick-up location corresponding to a historical start location in a historical service order can be found elsewhere in the present disclosure. See, e.g., FIG. 7 and the relevant descriptions.

In 620, the determination module 420 may determine the one or more candidate pick-up locations based on the one or more historical pick-up locations corresponding to the one or more historical start locations. In some embodiments, the determination module 420 may designate all of the historical pick-up location(s) as the candidate pick-up location(s). In some embodiments, the determination module 420 may designate a portion of the one or more historical pick-up locations as the candidate pick-up location(s) based on one or more selection criteria. The selection criteria may include but not be limited to a distance between the historical pick-up location and the start location, the number of times or frequency that the historical pick-up location served as a historical start location, a historical destination, or a historical pick-up location, or the like, or any combination thereof. For example, the historical pick-up location(s) within a threshold distance to the start location may be designated as candidate pick-up location(s). In some embodiments, the determination module 420 may remove duplicate historical start location(s) among the historical start location(s), and designate the remaining historical start location(s) as the candidate pick-up location(s).

FIG. 7 is a flowchart illustrating an exemplary process for determining a historical pick-up location corresponding to a historical start location in a historical service order according to some embodiments of the present disclosure. At least a portion of process 700 may be implemented on the computing device 200 as illustrated in FIG. 2 or the mobile device 300 as illustrated in FIG. 3. In some embodiments, one or more operations of process 700 may be implemented in the O2O service system 100 as illustrated in FIG. 1. In some embodiments, one or more steps in the process 700 may be stored in the storage device 160 and/or the storage (e.g., the ROM 230, the RAM 240, etc.) as a form of instructions, and invoked and/or executed by the server 110 (e.g., the processing engine 112 in the server 110, or the CPU 220 of the processing engine 112 in the server 110). In some embodiments, the process 700 may be repeatedly performed for each of the historical start locations in operation 610 as described in connection with FIG. 6.

In 710, the acquisition module 410 may obtain a first route of a historical requester terminal corresponding to a historical start location. In 720, the acquisition module 410 may obtain a second route of a historical provider terminal corresponding to the historical start location. In some embodiments, the historical requester terminal corresponding to the historical start location may refer to the requester terminal that initiated a historical service order from the historical start location. In some embodiments, the historical provider terminal corresponding to the historical start location may refer to the provider terminal that accepted the historical service order initiated by the historical requester terminal from the historical start location.

The first route may refer to a travelled path of the historical requester terminal in at least part of the process of the historical service order. For example, the first route may include the travelled path of the historical requester terminal in the whole process of the historical service order (i.e., from the historical start location to the destination). As another example, the first route may include the travelled path of the historical requester terminal from the historical start location to a location at the converge portion of the first route and the second route. Merely by way of example, the routes of a passenger and a driver in a historical service order may converge after the driver picks up the passenger.

In some embodiments, the first route may include a plurality of points (or locations) of the historical requester terminal in at least part of the process of the historical service order. In some embodiments, the historical requester terminal may be a device with positioning technology for locating the historical requester terminal. Additionally or alternatively, the historical requester terminal may communicate with another positioning device to determine the location of the historical requester terminal. The historical requester terminal may continuously or periodically transmit its location to the server 110 (e.g., the processing engine 112). For example, the historical requester terminal may transmit its location to the processing engine 112 periodically (e.g., every 3 seconds). In some embodiments, the processing engine 112 (e.g., the determination module 420) may then determine the first route by connecting the locations received from the historical requester terminal.

In certain embodiments, the processing engine 112 (e.g., the determination module 420) may further divide the points in the first route into one or more first point sets according to a division rule. For example, the determination module 420 may divide the points into the first point set(s) according to a predetermined time interval (e.g., 10 s, 30 s, 50 s, or 100 s). One or more points received from the historical requester terminal within the predetermined time interval may be put into a same first point set. As another example, the determination module 420 may divide the points into the first point set(s) according to a predetermined distance (e.g., 0.1 m, 0.5 m, 1 m, or 3 m). One or more points having distances between each other being less than the predetermined distance and forming a cluster-like group may be put into a same first point set. In some embodiments, different first point sets may include different points. Additionally or alternatively, different first point sets may include one or more same points.

In some embodiments, the division rule (e.g., the predetermined time interval) may be set by a user of the O2O service system 100 or be determined by one or more components in the O2O service system 100 (e.g., the determination module 420). In some embodiments, the division rule may be adjusted according to different situations. Merely by way of example, the predetermined time interval in rush hours (e.g., 7:00 to 9:00 a.m.) may be longer than that in off-peak hours (e.g., 14:00 to 16:00 p.m.). In some embodiments, the determination module 420 may further transmit the first route (including the points and/or first point sets of the first route) to a storage device (e.g., the storage device 160) for storage. The acquisition module 410 may access and retrieve the first route from the storage device.

The second route may refer to a travelled path of the historical provider terminal in at least part of the process of historical service order. In some embodiments, the second route may include a plurality of points (or locations) of the historical provider terminal in at least part of the process of the historical service order. In certain embodiments, the second route may include one or more second point sets. The determination module 420 may divide the points of the second route into the one or more second point sets according to a division rule. For example, the determination module 420 may divide the points of the second route into the second point set(s) according to a predetermined time interval (e.g., 10 s, 30 s, 50 s, or 100 s). One or more points received from the historical provider terminal within the predetermined time interval may be put into a same second point set. As another example, the determination module 420 may divide the points into the second point set(s) according to a predetermined distance (e.g., 0.1 m, 0.5 m, 1 m, or 3 m). One or more points having distances between each other being less than the predetermined distance and forming a cluster-like group may be put into a same second point set. In some embodiments, the points of the first route and the points of the second route may be divided according to a same division rule.

In 730, the determination module 420 may determine a converging point of the first route and the second route. In some embodiments, the converging point may refer to a meeting point of the first route and the second route after which the first route and the second route started to overlap with each other. In certain embodiments, the first route may include one or more first point sets and the second route may include one or more second point sets as described in connection with steps 710 and 720. The converging point may be determined based on a matching pair of first point set and second point set among the one or more first point sets and the one or more second point sets. In some embodiments, a first point set and a second point set collected at a same (or substantially same) time point may be regarded as a pair of first point set and second point set. The matching pair of first point set and second point set may be the first pair in which the first point set and the second point set at least partially overlap with each other.

In some embodiments, the converging point may be a central point of the second point set of the matching pair. In some embodiments, as described in connection with operations 710 and 720, one or more points in the second route received from the historical provider terminal within the predetermined time interval may be put into a same second point set. The central point a second point set may be the point received at a time point closest to the middle of the predetermined time interval among the points in the second point set. In some embodiments, one or more points in the second route having distances between each other being less than the predetermined distance and forming a cluster-like group may be put into a same second point set. The central point of a second point set may be the point among the points in the second point set closest to a midpoint of a route connecting the points in the second point set, or a midpoint of a line connecting the farthest two points in the second point set.

In 740, the determination module 420 may designate the converging point as the historical pick-up location corresponding to the historical start location. In some embodiments, after the converging point is determined, the determination module 420 may further project the coordinates of the converging point to a road map that includes the surroundings of the historical start location. The road map may be a new road map or a historical road map at the time when the historical requester terminal initiated the historical service order from the historical start location. If the converging point is projected to a point at a link in the road map, the determination module 420 may designate the converging point as the historical pick-up location. If the converging point is projected to a point that is located outside of any link in the road map, the determination module 420 may designate a location where the historical provider (e.g., a driver) began to charge the historical requester terminal for service as the historical pick-up location.

FIG. 8 is a flowchart illustrating an exemplary process for determining whether a candidate pick-up location is selected as a recommended pick-up location according to some embodiments of the present disclosure. At least a portion of process 800 may be implemented on the computing device 200 as illustrated in FIG. 2 or the mobile device 300 as illustrated in FIG. 3. In some embodiments, one or more operations of process 800 may be implemented in the O2O service system 100 as illustrated in FIG. 1. In some embodiments, one or more steps in the process 800 may be stored in the storage device 160 and/or the storage (e.g., the ROM 230, the RAM 240, etc.) as a form of instructions, and invoked and/or executed by the server 110 (e.g., the processing engine 112 in the server 110, or the CPU 220 of the processing engine 112 in the server 110). In some embodiments, the process 800 may be repeatedly performed for each of the one or more candidate pick-up locations to achieve operation 540 as described in connection with FIG. 5.

In 810, the selection module 430 may identify an optimal route from a start location to a candidate pick-up location. In some embodiments, the optimal route may be selected among a plurality of possible routes from the start location to the candidate pick-up location in a road map including the surroundings of the start location. In some embodiments, the optimal route may be selected based on, such as but not limited to a traveling time, a travelling distance (e.g., a straight-line distance or a route distance), a number of traffic lights, requester's preferences, or the like, or any combination thereof. For example, a route with shortest travelling time among the possible routes may be selected as the optimal route. In some embodiments, the optimal route may be a straight line connecting the start location and the candidate pick-up location.

In 820, the selection module 430 may determine whether the optimal route includes road-crossing. In some embodiments, if a user has to cross a link (or road) along the optimal route, the selection module 430 may determine that the optimal route includes road-crossing. On the other hand, if a user doesn't need to cross any link (or road) along the optimal route, the selection module 430 may determine that the optimal route doesn't include road-crossing. In some embodiments, the selection module 430 may obtain one or more links where other candidate pick-up locations are located, and determine whether the optimal route is intersecting with the one or more links where other candidate pick-up locations are located. Upon a determination that the optimal route is intersecting with the one or more links where other candidate pick-up locations are located, the selection module 430 may determine that the optimal route includes road-crossing. On the other hand, if the optimal route is not intersecting with the one or more links where other candidate pick-up locations are located, the selection module 430 may determine that the optimal route doesn't include road-crossing.

In response to a determination that the optimal route includes the road-crossing, the processing engine 112 may execute the process 800 to 830. In 830, the selection module 430 may remove the corresponding candidate pick-up location as a possible recommended pick-up location.

In response to a determination that the optimal route doesn't include the road-crossing, the processing engine 112 may execute the process 800 to 840. In 840, the selection module 430 may designate the candidate pick-up location as a recommended pick-up location. In some embodiments, the recommended pick-up location may further be transmitted to the requester terminal.

In some embodiments, the process 800 may be repeatedly performed for one or more candidate pick-up locations corresponding to the start location to determine whether the candidate pick-up location is selected as a recommended pick-up location. If all of the candidate pick-up location(s) are removed and there is no possible recommended pick-up location, the selection module 430 may select the recommended pick-up location(s) among the candidate pick-up locations according to other selection techniques as described elsewhere in this disclosure (e.g., operation 540 and the descriptions thereof). For example, the selection module 430 may select the recommended pick-up location(s) based on the respective distances between the candidate pick-up locations and the start location. In some embodiments, the determination module 420 may re-determine one or more other candidate pick-up locations corresponding to the start location by implementing operation 520.

### EXAMPLES

FIG. 9 illustrates an exemplary road map surrounding a historical start location 910 according to some embodiments of the present disclosure. As illustrated in FIG. 9, the historical start location 910 has two candidate pick-up locations, i.e., candidate pick-up location A and candidate pick-up location B. The candidate pick-up location A locates in the Link 2. Route 920 represents an optimal route from the historical start location 910 to the candidate pick-up location A, along which a user has to cross the Link 1. Accordingly, since the route 920 may include road-crossing, the candidate pick-up location A may be removed as a possible recommended pick-up location as described in connection with FIG. 8. Similarly, since route 930 from the historical start location 910 to the candidate pick-up location B may include road-crossing, the candidate pick-up location B may also be removed as a possible recommended pick-up location. It should be noted that the example illustrated in FIG. 9 is merely provided for the purposes of illustration, and not intended to limit the scope of the present disclosure. The historical start location 910, the candidate pick-up location A, and/or the candidate pick-up location B may located at any positon in a road map.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system, comprising:
at least one computer-readable storage medium including a set of instructions;
at least one processor in communication with the at least one computer-readable storage medium, wherein when executing the instructions, the at least one processor is directed to:
obtain a start location from a requester terminal;
determine one or more candidate pick-up locations based on the start location and historical data, which include one or more historical start locations within a threshold distance from the start location;
obtain location information of the one or more candidate pick-up locations;
select, among the one or more candidate pick-up locations, one or more recommended pick-up locations based on the location information of the one or more candidate pick-up locations; and
transmit, to the requester terminal, the one or more recommended pick-up locations.

2. The system of claim 1, wherein to determine the one or more candidate pick-up locations based on the start location and the historical data, the at least one processor is further directed to:
determine a historical pick-up location corresponding to each of the one or more historical start locations based on the historical data; and
determine, based on the one or more historical pick-up locations corresponding to the one or more historical start locations, the one or more candidate pick-up locations.

3. The system of claim 2, wherein to determine the historical pick-up location corresponding to each of the one or more historical start locations, the at least one processor is further directed to:
obtain a first route of a historical requester terminal corresponding to the historical start location;
obtain a second route of a historical provider terminal corresponding to the historical start location;
determine a converging point of the first route and the second route; and
designate the converging point as the historical pick-up location corresponding to the historical start location when the converging point is projectable to a link in an updated road map.

4. The system of claim 3, wherein:
the first route includes one or more first point sets, each first location set reflecting a historical location of the historical requester terminal,
the second route includes one or more second point sets, each second point set reflecting a historical location of the historical provider terminal, and
to determine the converging point of the first route and the second route, the at least one processor is further directed to:
determine, among the one or more first point sets and the one or more second point sets, a matching pair of first point set and second point set; and
determine, based on the second point set of the matching pair, the converging point of the first route and the second route.

5. The system of claim 1, wherein:
to select the one or more recommended pick-up locations, the at least one processor is further directed to:
for each of the one or more candidate pick-up locations,
identify an optimal route from the start location to each of the one or more candidate pick-up locations;
determine whether each of the optimal route includes road-crossing; and
upon a determination that the optimal route includes road-crossing, remove the corresponding candidate pick-up location as a possible recommended pick-up location.

6. The system of claim 1, wherein to transmit, to the requester terminal, the one or more recommended pick-up locations, the at least one processor is further directed to:
rank the one or more recommended pick-up locations; and
transmit, to the requester terminal, part or all of the one or more recommended pick-up locations based on the ranking result.

7. The system of claim 6, wherein to rank the one or more recommended pick-up locations, the at least one processor is further directed to:
obtain usage information related to one or more historical start locations corresponding to the one or more recommended pick-up location; and
rank the one or more recommended pick-up locations based on the usage information.

8. The system of claim 6, wherein to rank the one or more recommended pick-up locations, the at least one processor is further directed to:
obtain link information related to the one or more recommended pick-up locations; and
rank the one or more recommended pick-up locations based on the link information.

9. The system of claim 1, wherein when executing the instructions, the at least one processor is further directed to:
update a road map including a plurality of links surrounding the start location.

10. A method implemented on a computing device having at least one processor, at least one computer-readable storage medium, and a communication platform connected to a network, comprising:
obtaining a start location from a requester terminal;
determining one or more candidate pick-up locations based on the start location and historical data, which include one or more historical start locations within a threshold distance from the start location;
obtaining location information of the one or more candidate pick-up locations;
selecting, among the one or more candidate pick-up locations, one or more recommended pick-up locations based on the location information of the one or more candidate pick-up locations; and
transmitting, to the requester terminal, the one or more recommended pick-up locations.

11. The method of claim 10, wherein the determining the one or more candidate pick-up locations based on the start location and the historical data includes:
determining a historical pick-up location corresponding to each of the one or more historical start locations based on the historical data; and
determining, based on the one or more historical pick-up locations corresponding to the one or more historical start locations, the one or more candidate pick-up locations.

12. The method of claim 11, wherein determining the historical pick-up location corresponding to each of the one or more historical start locations includes:
obtaining a first route of a historical requester terminal corresponding to the historical start location;
obtaining a second route of a historical provider terminal corresponding to the historical start location;
determining a converging point of the first route and the second route; and
designating the converging point as the historical pick-up location corresponding to the historical start location when the converging point is projectable to a link in an updated road map.

13. The method of claim 12, wherein:
the first route includes one or more first point sets, each first location set reflecting a historical location of the historical requester terminal,
the second route includes one or more second point sets, each second point set reflecting a historical location of the historical provider terminal, and
determining the converging point of the first route and the second route includes:
determining, among the one or more first point sets and the one or more second point sets, a matching pair of the first point set and the second point set; and
determining, based on the second point set of the matching pair, the converging point of the first route and the second route.

14. The method of claim 10, wherein the selecting the one or more recommended pick-up locations includes:
for each of the one or more candidate pick-up locations,
identifying an optimal route from the start location to each of the one or more candidate pick-up locations;
determining whether each of the optimal route includes road-crossing; and
upon a determination that the optimal route includes road-crossing, removing the corresponding candidate pick-up location as a possible recommended pick-up location.

15. The method of claim 10, wherein the transmitting, to the requester terminal, the one or more recommended pick-up locations includes:
ranking the one or more recommended pick-up locations; and
transmitting, to the requester terminal, part or all of the one or more recommended pick-up locations based on the ranking result.

16. The method of claim 15, wherein the ranking the one or more recommended pick-up locations includes:
obtaining usage information related to one or more historical start locations corresponding to the one or more recommended pick-up location; and
ranking the one or more recommended pick-up locations based on the usage information.

17. The method of claim 16, wherein the ranking the one or more recommended pick-up locations includes:
obtaining link information related to the one or more recommended pick-up locations; and
ranking the one or more recommended pick-up locations based on the link information.

18. The method of claim 10, wherein executing the instructions includes:
updating a road map including a plurality of links surrounding the start location.

19. A non-transitory computer-readable storage medium storing instructions that, when executed by at least one processor of a system, cause the system to perform a method, the method comprising:
obtaining a start location from a requester terminal;
determining one or more candidate pick-up locations based on the start location and historical data, which include one or more historical start locations within a threshold distance from the start location;
obtaining location information of the one or more candidate pick-up locations;
selecting, among the one or more candidate pick-up locations, one or more recommended pick-up locations based on the location information of the one or more candidate pick-up locations; and
transmitting, to the requester terminal, the one or more recommended pick-up locations.

20. The non-transitory computer-readable storage medium of claim 19, wherein the determining the one or more candidate pick-up locations based on the start location and the historical data includes:
determining a historical pick-up location corresponding to each of the one or more historical start locations based on the historical data; and
determining, based on the one or more historical pick-up locations corresponding to the one or more historical start locations, the one or more candidate pick-up locations.
